(19) United States
(12) Patent Application Publication
(10) Pub. No.: US 2023/0182006 A1
(43) Pub. Date: Jun. 15, 2023

(54) GAMING MACHINE

(71) Applicant: Shenzhen Zesum Technology Co., Ltd., Shenzhen (CN)

(72) Inventors: Wentao HU, Shenzhen (CN); Paofeng WEI, Shenzhen (CN); Chaoxian CHEN, Shenzhen (CN)

(73) Assignee: Shenzhen Zesum Technology Co., Ltd., Shenzhen (CN)

(21) Appl. No.: 17/889,089

(22) Filed: Aug. 16, 2022

(30) Foreign Application Priority Data
Dec. 13, 2021 (CN) 202111519299.8

(51) Int. Cl. A63F 13/24

(52) U.S. Cl. CPC A63F 13/24

(57) ABSTRACT

A gaming machine includes a main body, a handle, a guide assembly and a limit assembly. A side wall surface of the main body is provided with a sliding rail. A sliding groove is formed in a sliding rail along an extending direction of the sliding rail. A side wall surface of the handle is provided with a sliding block detachably inserted in the sliding groove along an extending direction of the sliding groove, to electrically connect the handle to the main body. The guide assembly includes a first guide member provided on the main body and a second guide member provided on the handle. The first guide member and the second guide are magnetically attracted to guide the sliding block to be inserted into the sliding groove. The limit assembly limits and fixes the sliding block in the sliding groove relative to the sliding rail.

### CROSS-REFERENCE TO RELATED APPLICATIONS

This application claims priority to Chinese Patent Application No. 202111519299.8, filed on Dec. 13, 2021, and entitled “GAMING MACHINE”, which is hereby incorporated by reference in its entirety.

### TECHNICAL FIELD

This application relates to the technical field of game equipment, in particular to a gaming machine.

### BACKGROUND

A gaming machine in the related art includes a main body and a handle which is usually fixedly connected to the main body. Therefore, the main body and the handle of this type of gaming machine are usually in an integrated structure, so that the whole gaming machine needs to be replaced when a damage occurs on one of the main body and the handle, which results in an increase in maintenance and replacement costs of the gaming machine.

### SUMMARY

The main purpose of this application is to provide a gaming machine, which aims to reduce maintenance and replacement costs of the gaming machine.

In order to achieve the above purpose, the gaming machine disclosed by this application includes:
a main body, in particular a side wall surface of the main body is provided with a sliding rail, and a sliding groove is formed in the sliding rail along an extending direction of the sliding rail;
a handle, in particular a side wall surface of the handle is provided with a sliding block, and the sliding block is detachably inserted in the sliding groove along an extending direction of the sliding groove, to electrically connect the handle to the main body;
a guide assembly including a first guide member and a second guide member, in particular the first guide member is provided on the main body, the second guide member is provided on the handle and opposite to the first guide member, and the first guide member and the second guide are magnetically attracted to guide the sliding block to be inserted into the sliding groove; and
a limit assembly configured for limiting and fixing the sliding block inserted into the sliding groove relative to the sliding rail.

Optionally, a side wall of the sliding groove is provided with a snap hole, and the limit assembly includes a buckle, the buckle is arranged on the sliding block and is capable of being elastically clamped into the snap hole to limit and fix the sliding block inserted into the sliding groove relative to the sliding rail.

Optionally, the buckle is slidably disposed on the sliding block, and the limit assembly further includes an elastic member connected to the sliding block and the buckle, and configured to drive the buckle to move relatively to the sliding block to snap into the snap hole.

Optionally, the sliding block is provided with an accommodating notch on a side close to the handle, and the limit assembly further includes a fixing piece, the fixing piece is connected to the sliding block and encloses the accommodating notch to form a slide channel extending along a sliding direction of the buckle, and the elastic member and the buckle are both arranged in the slide channel.

Optionally, the fixing piece is fixed to the sliding block by a screw; and/or,

the sliding block is provided with insertion grooves on opposite sides of the accommodating notch, and opposite sides of the fixing piece are provided with insertion pieces, and each insertion piece is inserted into one of the insertion grooves.

Optionally, the handle is provided with a button adjacent to a wall surface where the sliding block is provided, and the button is configured to abut and drive the buckle to slide relatively to the sliding block to be separated from the snap hole when the button is pressed by an external force.

Optionally, the first guide member and the second guide member are both magnets.

Optionally, the main body is defined to have a first end and a second end opposite to each other in the extending direction of the sliding rail, the first guide member is disposed at the first end, and the limit assembly is disposed at the second end.

Optionally, a side wall surface of the main body is further provided with a mounting groove, the mounting groove is extended along the extending direction of the sliding rail, and both the sliding rail and the first guide member are embedded in the mounting groove.

Optionally, a surface of the sliding rail facing away from a groove bottom wall of the mounting groove is flush with a surface of the first guide member facing away from the groove bottom wall of the mounting groove.

When the handle of the gaming machine according to an aspect of the present application is assembled to the main body, the sliding block on the handle is inserted into the sliding groove of the sliding rail along the extending direction of the sliding rail on the main body. After that, the sliding block inserted into the sliding groove is limited and fixed by the limit assembly, so that the mechanical assembly of the two can be completed, and the electrical connection between the handle and the main body can be ensured. Moreover, since the handle in this embodiment is detachably inserted into the main body, when one of the handle and the main body is damaged, the handle and the main body can be disassembled and separated from each other and only the damaged one will be repaired or replaced. This eliminates the need to repair or replace the entire gaming machine, and reduces costs of repair and replacement of the gaming machine.

Further, the gaming machine in this solution further includes a guide assembly, which includes a first guide member provided on the main body and a second guide part provided on the handle, and the second guide member and the first guide member are attracted by magnetic force to guide the sliding block to be inserted into the sliding rail. At this time, the inserting of the sliding block of the handle into the sliding rail can be more smoothly, labor-saving and quickly through magnetic guidance between the second guide member and the first guide member of the guide assembly, thereby improving convenience of assembly of the gaming machine. Moreover, after the handle is assembled on the main body, the handle is mounted on the main body by magnetic fixation between the first guide member and the second guide member of the guide assembly. In this way, the handle can not only be limited and fixed by the limit assembly, but also be further limited and fixed by the magnetic attraction between the first guide member and the second guide member of the guide assembly, thereby greatly improving the stability of the handle installed on the main body.

### BRIEF DESCRIPTION OF THE DRAWINGS

In order to more clearly illustrate the technical solutions in the embodiments of the application or in the related art, the following briefly introduces the accompanying drawings that need to be used in the description of the embodiments or the related art. Obviously, the accompanying drawings in the following description are only some embodiments of the application. For those of ordinary skill in the art, without creative labor, other drawings can also be obtained according to the structure shown in these drawings.

FIG. 1 is a schematic front exploded view of a gaming machine according to an embodiment of the present application.

FIG. 2 is a schematic back exploded view of the gaming machine of FIG. 1.

FIG. 3 is a schematic view showing a back of a handle of the gaming machine of FIG. 1.

FIG. 4 is a schematic exploded view showing the back of the handle of FIG. 3.

FIG. 5 shows a sliding block in FIG. 4.

FIG. 6 is a schematic exploded view of the sliding block of FIG. 5.

FIG. 7 is a structural view showing a back of a main body of the gaming machine of FIG. 1.

FIG. 8 is an enlarged view of portion A in FIG. 7.

FIG. 9 is a schematic exploded view showing a front of the handle in FIG. 1.

The realization of the purposes, functional features and advantages of this application will be further described in combination with the embodiments and with reference to the accompanying drawings.

### DETAILED DESCRIPTION OF THE EMBODIMENTS

The technical solutions in the embodiments of the application will be clearly and completely described below with reference to the accompanying drawings in the embodiments of the application. Obviously, the described embodiments are only a part of the embodiments of the application, rather than all of the embodiments. Based on the embodiments in the application, all other embodiments obtained by those of ordinary skill in the art without making creative labor belong to the scope of protection of the application.

It should be noted that all directional indications (such as up, down, left, right, front, back, etc.) in the embodiment of the application are only used to explain the relative positional relationship, movement situation, etc. between the components under a specific posture (as shown in the drawings), if the specific posture changes, the directional indication also changes accordingly.

In the application, unless otherwise expressly specified and limited, the terms “connection”, “fixed”, etc. should be understood in a broad sense. For example, “fixed” can be a fixed connection, a detachable connection, or be integrated into one. It can be a mechanical connection or an electrical connection. It can be a direct connection or an indirect connection through an intermediate medium, it can be the internal communication of the two elements or the interaction relationship between the two elements, unless otherwise clearly defined. For those of ordinary skill in the art, the specific meaning of the above terms in the application can be understood according to specific circumstances.

In addition, the description relating to “first”, “second” and the like in the application is for descriptive purposes only and cannot be understood as indicating or implying their relative importance or implying the number of technical features indicated. Thus, the feature defining the “first” and “second” may explicitly or implicitly include at least one of the features. In addition, the technical solutions between the various embodiments may be combined with each other, but they must be based on those of ordinary skill in the art. When the combination of the technical solutions contradicts each other or cannot be realized, it should be considered that the combination of the technical solutions does not exist and is not within the scope of protection required by the application.

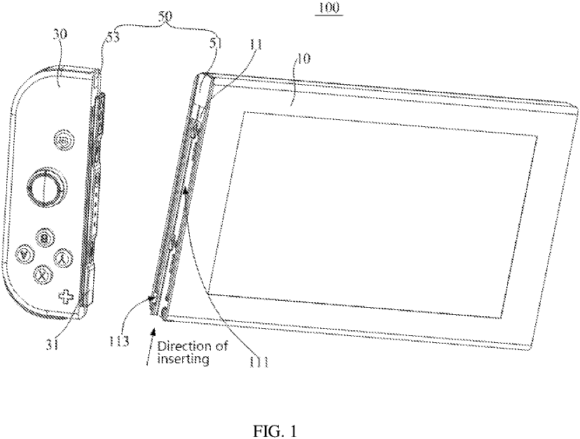

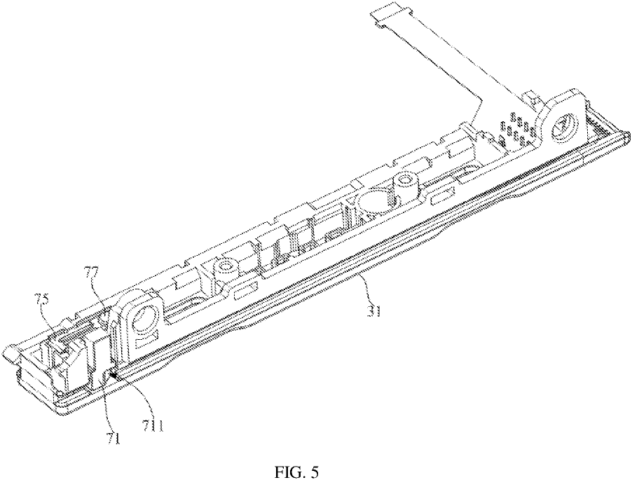

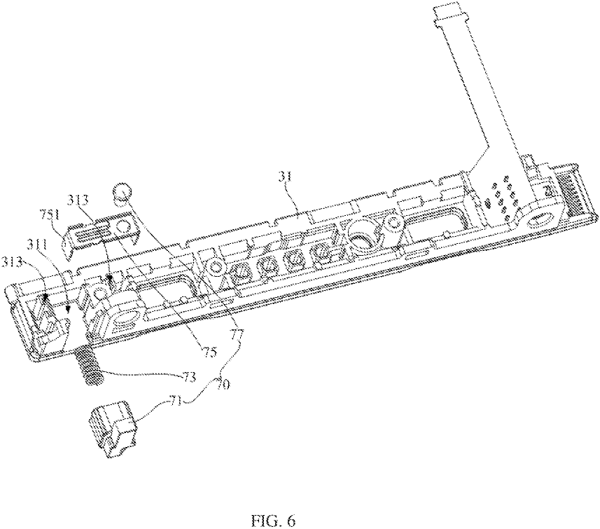

According to FIGS. 1 to 6, the present application provides a gaming machine 100. In an embodiment of the present application, the gaming machine 100 includes a main body 10, a handle 30, a guide assembly 50 and a limit assembly 70. A side wall surface of the main body is provided with a sliding rail 11, and a sliding groove 111 is formed in the sliding rail 11 along an extending direction of the sliding rail 11. A side wall surface of the handle 30 is provided with a sliding block 31. The sliding block 31 is detachably received in the sliding groove 111 along the extending direction of the sliding groove 111, so that the handle 30 is electrically connected to the main body 10. The guide assembly 50 includes a first guide member 51 and a second guide member 53. The first guide member 51 is provided on the main body 10, and the second guide part is provided on the handle 30 and opposite to the first guide member 51. The first guide member 51 and the second guide member are magnetically attracted to guide the sliding block 31 to be inserted into the sliding groove 111. The limit assembly 70 is configured to limit and fix the sliding block 31 in the sliding groove 111 relative to the sliding rail 11.

In an embodiment of the present application, the main body 10 is configured for displaying a game interface, and is further configured for receiving an operation instruction transmitted from the handle 30, so as to perform corresponding control during the game. In particular, the main body 10 can be roughly a rectangular parallelepiped structure, and has a relatively regular shape, so as to improve convenience of processing and molding the main body 10. Certainly, it should be noted that, this application is not limited to this, and in other embodiments, the main body 10 may be roughly a square structure, a cylindrical structure, or in another shape. The sliding rail 11 on the side wall surface of the main body 10 is configured to form the sliding groove 111, so that the sliding block 31 on the side wall surface of the handle 30 is inserted to complete the mechanical assembly and electrical connection between the handle 30 and the main body 10. In particular, when only one handle 30 is included, only one side wall surface of the main body 10 is provided with the sliding rails 11. When two handles 30 are provided, two opposite side wall surfaces of the main body 10 are both provided with a sliding rail 11, so that handles are respectively installed on opposite sides of the main body 10 to adapt to the left and right hands of the user. A cross section of the sliding rail 11 in a direction perpendicular to an extending direction thereof is substantially U-shaped, so as to simplify the structure of the sliding rail 11 and improve the convenience of processing and forming the sliding rail 11. The handle 30 may be provided with an operation key for the user to input the operation instruction and transmit the operation instruction to the main part 10 when an operation key function is triggered. In particular, the handle 30 is also substantially a rectangular parallelepiped structure, so that its shape is more regular and easier to process and form. Certainly, this application is not limited to this. In other embodiments, the handle 30 may be a substantially cubic structure or in another shape. The sliding block 31 is provided on a side wall surface of the handle 30 opposite to the main body 10. The guide assembly 50 may be used to guide an insertion process of the sliding block 31 when the sliding block 31 on the handle 30 is inserted into the sliding rail 11 on the main body 10. Specifically, the guide assembly 50 includes a first guide member 51 provided on the main body 10 and a second guide member 53 provided on the handle 30, and the second guide member 53 and the first guide member 51 are attracted to each other by magnetic force. In this way, when the sliding block 31 is inserted into the sliding rail 11, the mutual attraction between the second guide 53 and the first guide 51 can guide the sliding block 31 to be inserted into the sliding rail 11 more smoothly and quickly. At the same time, after the sliding block 31 is inserted and located in place, a connection between the handle 30 and the main body 10 is limited by the magnetic fixation between the first guide member 51 and the second guide member 53. The limit assembly 70 is configured to limit the sliding block 31 inserted into the sliding groove 111, so that the sliding block can no longer slide relatively to the sliding rail 11 after the sliding block is inserted in place on the sliding rail 11, so as to ensure stability of the connection between the handle 30 and the main body 10.

When the handle 30 of the gaming machine 100 according to an aspect of the present application is assembled to the main body 10, the sliding block 31 on the handle 30 is inserted into the sliding groove 111 of the sliding rail 11 along the extending direction of the sliding rail 11 on the main body 10. After that, the sliding block 31 inserted into the sliding groove 111 is limited and fixed by the limit assembly 70, so that the mechanical assembly of the two can be completed, and the electrical connection between the handle 30 and the main body 10 can be ensured. Moreover, since the handle 30 in this embodiment is detachably inserted into the main body 10, when one of the handle 30 and the main body 10 is damaged, the handle 30 and the main body 10 can be disassembled and separated from each other and only the damaged one will be repaired or replaced. This eliminates the need to repair or replace the entire gaming machine 100, and reduces costs of repair and replacement of the gaming machine 100.

Further, the gaming machine 100 in this solution further includes a guide assembly 50, which includes a first guide member 51 provided on the main body 10 and a second guide part provided on the handle 30, and the second guide member 53 and the first guide member 51 are attracted by magnetic force to guide the sliding block 31 to be inserted into the sliding rail 11. At this time, the inserting of the sliding block 31 of the handle 30 into the sliding rail 11 can be more smoothly, labor-saving and quickly through magnetic guidance between the second guide member 53 and the first guide member 51 of the guide assembly 50, thereby improving convenience of assembly of the gaming machine 100. Moreover, after the handle 30 is assembled on the main body 10, the handle 30 is mounted on the main body 10 by magnetic fixation between the first guide member 51 and the second guide member 53 of the guide assembly 50. In this way, the handle 30 can not only be limited and fixed by the limit assembly 70, but also be further limited and fixed by the magnetic attraction between the first guide member 51 and the second guide member 53 of the guide assembly 50, thereby greatly improving the stability of the handle 30 installed on the main body 10.

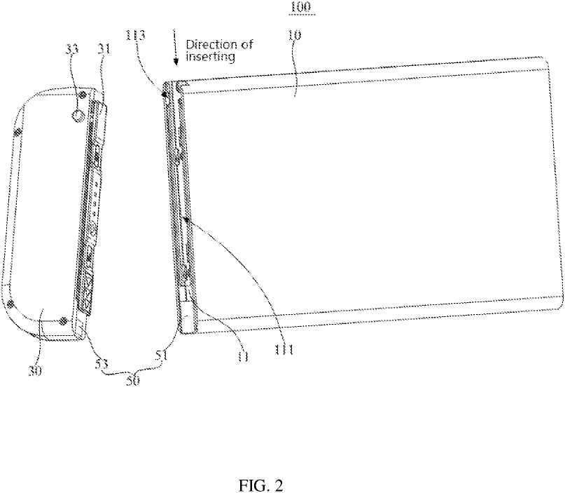

According to FIGS. 2 to 8, in an embodiment of the application, a side wall of the groove of the sliding groove 111 is provided with a snap hole 113, and the limit assembly 70 includes a snap 71, the snap 71 is disposed on the sliding block 31 and is elastically clamped into the snap hole 113, so that the sliding block 31 inserted into the sliding groove 111 is limited and fixed relative to the sliding rail 11.

In this embodiment, the limit assembly 70 is clamped and fixed through the snap 71 and the snap hole 113 on the side wall of the sliding groove 111, so that the sliding block 31 and the sliding rail 11 can be fixed when the snap 71 is elastically clamped into the snap hole 113, and the sliding block 31 and the sliding rail 11 can be unlocked when the snap 71 is detached from the snap hole 113. At this time, the fixing and unlocking processes are relatively simple, which facilitates convenience of insertion and removal processes of the handle 30 and the main body 10. Of course, it should be noted that, this application is not limited to this, and in other embodiments, the limit assembly 70 may also be a screw, that is, when the handle 30 is inserted in place, it is further possible for the screw to pass through the handle 30 and the main body 10 to be connect and fix the handle 30 and the main body 10.

In an embodiment of the application, the snap 71 is slidably disposed on the sliding block 31. The limit assembly 70 further includes an elastic member 73, the elastic member 73 is connected to the sliding block 31 and the snap 71, and can drive the snap 71 to move relatively to the sliding block 31 to snap into the snap hole 113.

In this embodiment, a driving force for driving the snap 71 can be continuously given by the elastic member 73, so that a clamping strength between the snap 71 and the snap hole 113 on the groove side wall of the sliding groove 111 is enhanced, which is beneficial to improve the stability of the clamping between the sliding block 31 and the sliding rail 11. In particular, a sliding direction of the snap 71 is perpendicular to the extending direction of the sliding rail 11, that is, after being driven by the elastic member 73, the snap 71 can be inserted into the snap hole 113 provided on one of the opposite two groove side walls of the sliding groove 111 of the sliding rail 11. The elastic member 73 may be a spring or a plastic member with certain elasticity. Further, in order to improve convenience of installation of the elastic member 73, the snap 71 may be provided with a receiving hole on a wall surface facing the elastic member 73, to accommodate a part of the elastic member 73 and realize an installation limit of the elastic member 73. Further, in order to improve convenience of inserting the handle 30 in the main body 10, the snap 71 may be provided with a guide surface 711 (the guide surface 711 may be an inclined plane or an arc surface) on one side facing the sliding block 31 in a direction of inserting the sliding rail 11, so that when the snap 71 enters into the sliding groove 111 of the sliding rail 11 with the sliding block 31, the snap 71 can be automatically retracted by abutting against a sidewall of the sliding groove 111. After being inserted and installed in place, that is, when the snap 71 faces the snap hole 113, the snap 71 will be popped out and clamped by the snap hole 113. In addition, it should be noted that this application is not limited to this. In other embodiments, the snap 71 itself may also be a silicone component or a rubber component, so that it has elasticity and can be directly elastically snapped into or out of the snap hole 113, so that the elastic component 73 can be omitted.

According to FIGS. 2 to 6, in an embodiment of the present application, the sliding block 31 is provided with an accommodating notch 311 on one side close to the handle 30, and the limit assembly 70 further includes a fixing piece 75. The fixing piece 75 is connected to the sliding block 31 and encloses the accommodating notch 311 to form a slide channel extending along a sliding direction of the snap 71, and the elastic component 73 and the snap 71 are both disposed in the slide channel.

In this embodiment, the snap 71 and the elastic member 73 are installed in the slide channel, so that the snap 71 and the elastic member 73 can be installed more compactly on the sliding block 31. At the same time, the slide channel further has a guiding effect on the sliding of the snap 71, so that the snap 71 can only slide along an extending direction of the slide channel and accurately snap into the snap hole 113. The slide channel is formed by the fixing piece 75 enclosing the accommodating notch 311, thus the slide channel can be formed by installing the fixing piece 75 on the sliding block 31 after the accommodating notch 311 formed by three walls is processed. At this time, structures of the accommodating notch 311 and the fixing piece 75 are relatively simple, which is beneficial to improve convenience of processing and forming the slide channel.

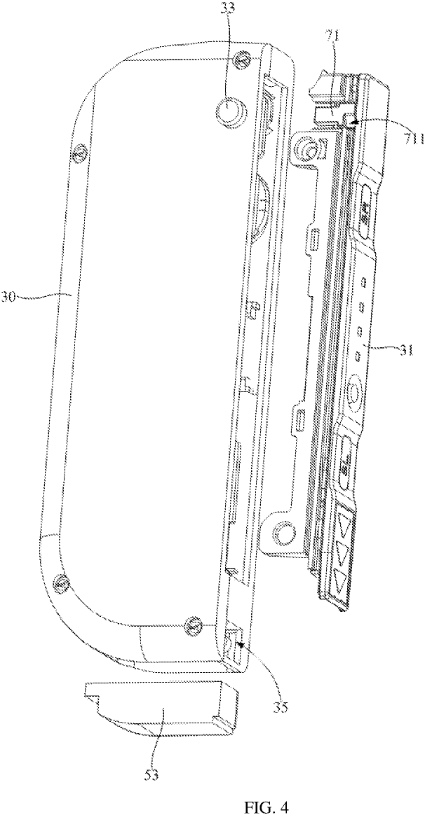

According to FIGS. 4 to 6, in an embodiment of this application, the fixing piece 75 is fixed to the sliding block 31 by a screw member 77.

In this embodiment, the fixing piece 75 is fixed by the screw member 77, so that the fixing piece 75 can be detached from the sliding block 31. Therefore, when the elastic member 73 or the snap 71 provided in the slide channel is damaged, the fixing piece 75 can be detached to realize that the elastic member 73 and the snap 71 can be detached, thereby further improving convenience of maintenance and replacement of the gaming machine 100. Moreover, the connection of the screw member 77 has an advantage of being simple and reliable, so that it is possible to simplify the disassembly and assembly process of the fixing piece 75 and improve the disassembly and assembly efficiency while ensuring the stability of the connection between the fixing piece 75 and the sliding block 31. In particular, the screw member 77 can be a screw. Of course, the screw member 77 can further be a combination of a stud and a nut. At this time, the studs are protruded on the sliding block 31. After the fixing piece 75 is installed on the sliding block 31, the nut are sleeved on the stud passed through the fixing piece 75, so that the nut and the sliding block 31 can cooperate to clamp the fixing piece 75. Of course, it should be noted that, this application is not limited to this, and in other embodiments, the fixing sheet 75 may be fixed to the sliding block 31 by gluing.

According to FIGS. 4 to 6, in an embodiment of this application, the sliding block 31 is provided with insertion grooves 313 on opposite sides of the accommodating notch 311, the opposite sides of the fixing piece 75 are provided with insertion pieces 751, and each insertion piece 751 is inserted into one of the insertion grooves 313.

In this embodiment, the fixing piece 75 is inserted into the insertion groove 313 on the sliding block 31 through the insertion piece 751, so that the fixing piece 75 and the insertion groove can be inserted and positioned in advance before being fixed by the screw member 77, thereby facilitating to improve accuracy of subsequent installation. At the same time, through the limit abutment between the insertion groove 313 and the insertion piece 751, a contact area between the fixing piece 75 and the sliding block 31 is further increased, thereby improving mounting stability of the fixing piece 75 on the sliding block 31.

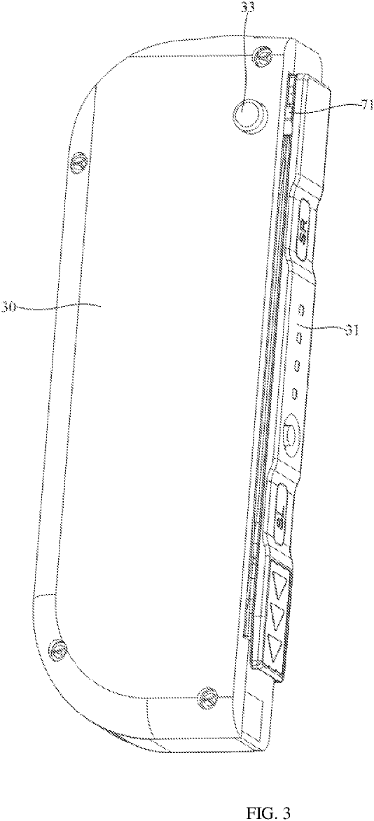

According to FIGS. 3 and 4, in an embodiment of this application, the handle 30 is provided with a button 33 adjacent to the wall surface provided with the sliding block 31. When the button 33 is pressed by an external force, the button 33 can abut and drive the snap 71 to slide relative to the sliding block 31 to be detached from the snap hole 113.

In this embodiment, the button 33 is arranged so that when the handle 30 needs to be pulled out and removed from the main body 10, the button 33 can be pressed to drive the snap 71 to squeeze the elastic member 73 and detach from the snap hole 113, thereby realizing the unlocking of the limit assembly 70 more conveniently. In particular, a side of the sliding block 31 provided with the accommodating notch 311 can be embedded in the handle 30, so that the button 33 provided on the handle 30 can be relatively located above the snap 71, and after pressing, the snap 71 can be driven by the button 33 to slide to achieve unlocking.

In an embodiment of this application, both the first guide member 51 and the second guide member 53 are magnets.

In this embodiment, both the first guide member 51 and the second guide member 53 are provided as magnets, so that both the first guide 51 and the second guide 53 have a relatively large magnetic force. At this time, an attracting force between the first guide 51 and the second guide 53 is increased, which is beneficial to improve a guiding action of the guide assembly 50 guiding the sliding block 31 on the handle 30 to be inserted into the sliding rail 11 of the main body 10, and after the insertion of the sliding block 31 is completed, stability of the connection between the handle 30 and the main body 10 can be further improved. Of course, it should be noted that this application is not limited to this. In other embodiments, only one of the first guide member 51 and the second guide member 53 may be a magnet, and the other is a metal capable of being magnetically attracted.

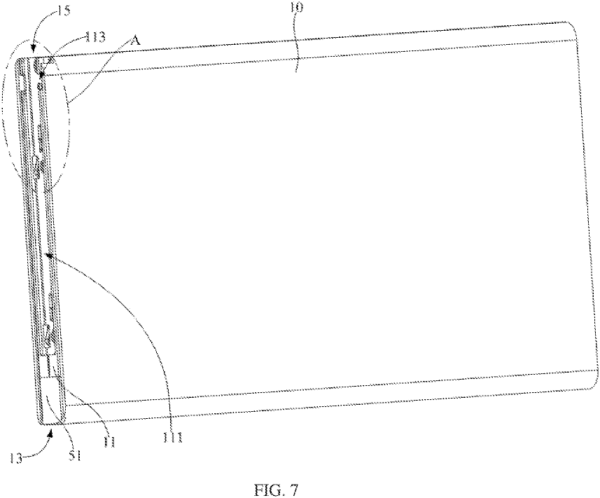

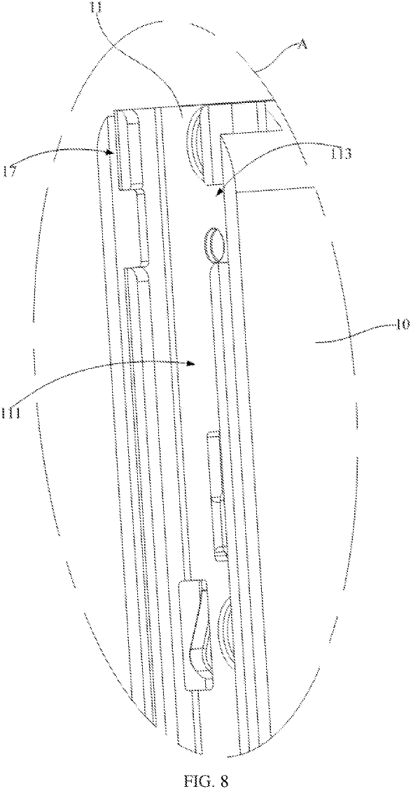

According to FIGS. 7 and 8, in an embodiment of the present application, it is defined that the main body 10 has a first end 13 and a second end 15 opposite to each other in the extending direction of the sliding rail 11, the first guide member 51 is disposed at the first end 13, and the limit assembly 70 is disposed at the second end 15.

In this embodiment, the first guide member 51 is disposed at the first end 13, and the limit assembly 70 is disposed at the second end 15 (it can also be said that the snap hole 113 is disposed at the second end 15), so that the handle 30 and the main body 10 can be fixed on one of the opposite ends by magnetic attraction, and the other one can be fixed by clamping, that is to say, it is ensured that the connection function is provided at both opposite ends to avoid the possibility that the end part is easily disengaged, thereby contributing to further improving the stability of the connection between the handle 30 and the main body 10. In particular, the first end 13 and the second end 15 are relative, that is, any one end of the main body 10 in the extending direction of the sliding rail can be defined as the first end 13, and the other end is the second end 15.

According to FIGS. 7 and 8, in an embodiment of the present application, a side wall surface of the main body 10 is further provided with a mounting groove 17. The mounting groove 17 is extended along the extending direction of the sliding rail 11, and both the sliding rail 11 and the first guide member 51 are embedded in the mounting groove 17.

In this embodiment, the sliding rail 11 and the first guide 51 are accommodated by the mounting groove 17, so that compactness of mounting the sliding rail 11 and the first guide 51 on the main body 10 can be improved, thereby facilitating the reduction of the overall volume of the main body 10 to improve the portability of use. Moreover, by providing both the sliding rail 11 and the first guide 51 in the mounting groove 17, contact areas between the sliding rail 11 and the main body 10 and between the first guide 51 and the main body 10 can be increased, thereby contributing to improving stability of mounting the sliding rail 11 and the first guide 51 on the main body 10. Of course, it should be noted that, this application is not limited to this, and in other embodiments, the sliding rail 11 and the first guide member 51 may be mounted on the side surfaces of the main body 10 and clearly visible.

According to FIG. 7, in an embodiment of this application, a surface of the sliding rail 11 facing away from a groove bottom wall of the mounting groove 17 is flush with a surface of the first guide 51 facing away from the groove bottom wall of the mounting groove 17.

In this embodiment, the surface of the sliding rail 11 facing away from the groove bottom wall of the mounting groove 17 is flush with the surface of the first guide member 51 facing away from the groove bottom wall of the mounting groove 17 are flush, so that the sliding rail 11 and the first guide member 51 can be arranged in the mounting groove 17 more regularly and more compact. Of course, it should be noted that this application is not limited to this. In other embodiments, it is further possible that the surface of the sliding rail 11 facing away from the groove bottom wall of the mounting groove 17 is lower than or higher than the surface of the first guide 51 facing away from the groove bottom wall of the mounting groove 17.

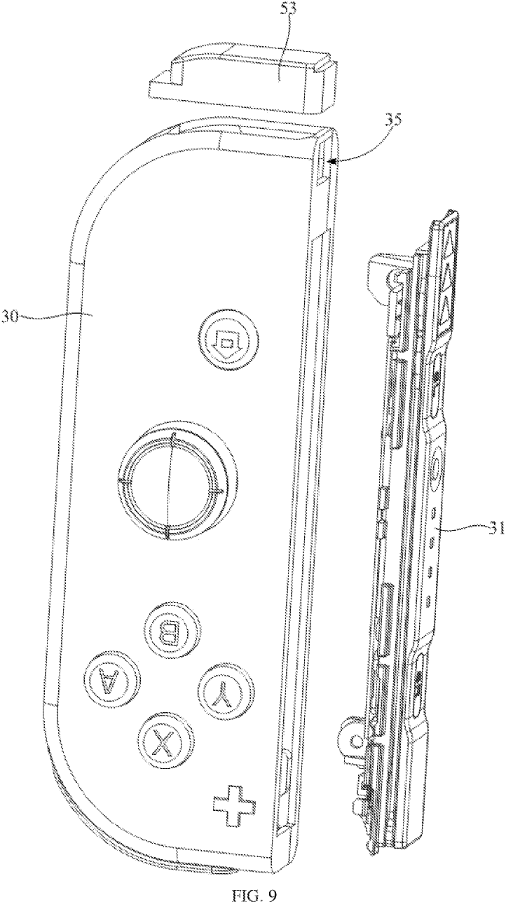

According to FIGS. 1 and 9, in an embodiment of the application, the handle 30 is further provided with a mounting hole 35, and the second guide 53 is embedded in the mounting hole 35.

In this embodiment, the second guide member 53 can be provided with an accommodating space through the mounting hole 35, so that the second guide member 53 can further be mounted on the handle 30 in a compact and stable manner. The shape of the mounting hole 35 can be adaptively set according to the shape of the second guide 53. For example, when the second guide 53 is substantially of a rectangular parallelepiped structure, the mounting hole 35 is correspondingly configured as a rectangular parallelepiped hole.

According to FIGS. 1 and 9, in an embodiment of the present application, a wall surface of the second guide 53 exposed to an outside is flush with a wall surface of the handle 30 provided with the mounting hole 35.

In this embodiment, the wall surface of the second guide 53 exposed to outside is flush with the wall surface of the handle 30 provided with the mounting hole 35, so that the second guide 53 can be completely accommodated in the mounting hole 35 to maximize compactness of the distribution of the wall surface of the second guide 53 and the mounting hole 35. At the same time, this arrangement also makes a side peripheral surface of the handle 30 relatively flat and ensures beauty of the appearance of the handle 30, thus helping to improve the competitiveness of subsequent products in the market.

The above description is only a preferred embodiment of the application, and does not therefore limit the patent scope of the application. Any equivalent structural transformation made by using the description of the application and the accompanying drawings, or direct/indirect application in other related technical fields under the inventive concept of the application, is included in the patent protection scope of the application.

1. A gaming machine, comprising:
a main body, wherein a side wall surface of the main body is provided with a sliding rail, and a sliding groove is formed in the sliding rail along an extending direction of the sliding rail;
a handle, wherein a side wall surface of the handle is provided with a sliding block, and the sliding block is detachably inserted in the sliding groove along an extending direction of the sliding groove, to electrically connect the handle to the main body;
a guide assembly comprising a first guide member and a second guide member, wherein the first guide member is provided on the main body, the second guide member is provided on the handle and opposite to the first guide member, and the first guide member and the second guide are magnetically attracted to guide the sliding block to be inserted into the sliding groove; and
a limit assembly configured for limiting and fixing the sliding block inserted into the sliding groove relative to the sliding rail.

2. The gaming machine according to claim 1, wherein a side wall of the sliding groove is provided with a snap hole, and the limit assembly comprises a buckle, the buckle is arranged on the sliding block and is capable of being elastically clamped into the snap hole to limit and fix the sliding block inserted into the sliding groove relative to the sliding rail.

3. The gaming machine according to claim 2, wherein the buckle is slidably disposed on the sliding block, and the limit assembly further comprises an elastic member connected to the sliding block and the buckle, and configured to drive the buckle to move relatively to the sliding block to snap into the snap hole.

4. The gaming machine according to claim 3, wherein the sliding block is provided with an accommodating notch on a side close to the handle, and the limit assembly further comprises a fixing piece, the fixing piece is connected to the sliding block and encloses the accommodating notch to form a slide channel extending along a sliding direction of the buckle, and the elastic member and the buckle are both arranged in the slide channel.

5. The gaming machine according to claim 4, wherein the fixing piece is fixed to the sliding block by a screw; and/or
the sliding block is provided with insertion grooves on opposite sides of the accommodating notch, and opposite sides of the fixing piece are provided with insertion pieces, and each insertion piece is inserted into one of the insertion grooves.

6. The gaming machine according to claim 2, wherein the handle is provided with a button adjacent to a wall surface where the sliding block is provided, and the button is configured to abut and drive the buckle to slide relatively to the sliding block to be separated from the snap hole when the button is pressed by an external force.

7. The gaming machine according to claim 1, wherein the first guide member and the second guide member are both magnets.

8. The gaming machine according to claim 1, wherein the main body is defined to have a first end and a second end opposite to each other in the extending direction of the sliding rail, the first guide member is disposed at the first end, and the limit assembly is disposed at the second end.

9. The gaming machine according to claim 8, wherein a side wall surface of the main body is further provided with a mounting groove, the mounting groove is extended along the extending direction of the sliding rail, and both the sliding rail and the first guide member are embedded in the mounting groove.

10. The gaming machine according to claim 9, wherein a surface of the sliding rail facing away from a groove bottom wall of the mounting groove is flush with a surface of the first guide member facing away from the groove bottom wall of the mounting groove.
